(19) United States
(12) Patent Application Publication
(10) Pub. No.: US 2002/0114024 A1
(43) Pub. Date: Aug. 22, 2002

(54) Scanner message display system and method thereof

(76) Inventor: Chui-Kuei Chiu, Hsinchu Hsien (TW)

Correspondence Address: J.C. Patents, Inc., 1340 Reynolds Ave., Suite 114, Irvine, CA, 92614, US

(21) Appl. No.: 09/791,021

(22) Filed: Feb. 22, 2001

(51) Int. Cl. H04N 1/46

(52) U.S. Cl. 358/505

(57) ABSTRACT

A scanner message display system and method thereof, for sending a message from the main control device to the scanner that displays the message. More particularly, the scanner message display system involves a main program, a memory and a display device. More specifically, the main program is in the main control device and detects the language and detects the selected message from the user. The message item provides the full text message, the font and the icon. The language is either detected from the main control program, or selected by the user. The memory is in the main control device and couples to the main control program and stores the message when the scanner is operating. The display device is on the scanner surface and displays the message that is stored in the memory.

### BACKGROUND OF THE INVENTION

1. Field of Invention

The present invention relates to a display device on a scanner, and displaying the controlled message. More specifically, the message is displayed according to a selected language.

2. Description of Related Art

Many advances in electronic devices are directed towards high speed, easy use, and more human friendly interfaces. Another large push for electronic devices is to make them smaller and lighter. The scanner a good example of these advances taking form in a computer peripheral electronic device.

FIG. 1 illustrates a conventional scanner 100 showing how it displays messages. The memory 106 of the scanner displays a controlling state, an error message, etc. But, the memory 106 does not have enough capacity to store messages. Therefore the scanner can only display a simple text message and cannot auto detect the language or the font, and it cannot display the icon on the display device.

### SUMMARY OF THE INVENTION

The invention provides a scanner message display system, for auto detecting the language or the font, and also for displaying the icon on the display device.

As embodied and broadly described herein, the invention provides a main control program, a memory, and a display device.

More particularly, the main control program operates inside the main control device. The main control program detects the language and the message that are both selected by the user. The program also can display full text messages, the fonts, and the icon. The language on the scanner is either automatically detected by the main control program, or selected by the user.

The memory is located inside the main control device, and couples to the main control program. The memory displays the message when the scanner is operating. The display device is on the scanner surface. The display device displays the language that is dependent on the memory that stores the message from the main control program.

This scanner message display system further includes an output/input device in the main control device, a memory, and an output/input device in the scanner.

More particularly, the output/input device of the main control device couples to the main control program. The output/input device receives the message from the scanner, and stores it in the memory for displaying the message on the display device of the scanner.

The memory is in the scanner and couples to the display device. The memory stores the selected message selected by the user. The output/input device of the scanner couples between the memory and the display device. The output/input device in the scanner stores the information from the memory and receives the selected message from the main control device, and displays the information on the display device.

This invention also introduces a scanner message display element. This element detects the information and displays the message on the scanner. The scanner message display element provides the main control program with detection of the language, and detects the message item that is selected by the user.

More particularly, the method of the main control program for automatically detecting the language or the language selected by the user.

This invention also introduces a scanner message display device, which displays the information from the main control program. The scanner message display device is on the scanner. The scanner sends the optional message to the main control device and displays the information from the main control device.

The display device is on the scanner surface and displays the language that is detected by the main control program and stores it in the memory. The display device displays the message according to the language from the memory.

This invention also introduces a scanner message display method and shows how the scanner displays the message that it receives from the main control program. The steps of the scanner message display method are as follows. First, the scanner connects to the main control program. Then, the optional message is coded and sent to the main control program. Next, the main control program receives the optional message. Finally the message displays on the display device of the scanner.

This invention also introduces a scanner message display method that shows how the main control program detect language either automatically or which is selected from the user on the scanner.

The steps of the scanner message display are as follows. First, the user enters the language to display on the scanner. If the user selects the language, then the scanner will display the message with the language selected; but if the user does not select the language, then the main control program automatically detects the language from the main control device. Next step, according the language, the scanner sets up the font or the icon. Then, the control device receives information from the scanner, . Finally the message is sent to the scanner.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a conventional block diagram;

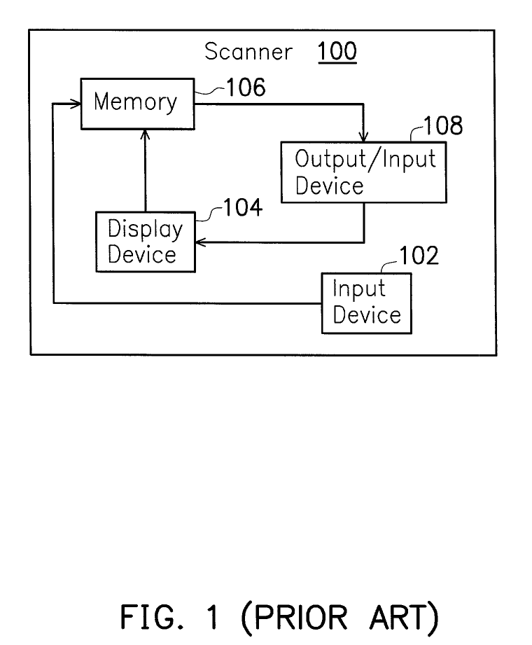

FIG. 2 is a block diagram according to one preferred embodiment of this invention; and

FIG. 3 is flow diagram according to one preferred embodiment of this invention; and

FIG. 4 is a flow diagram according to one preferred embodiment of this invention.

### DESCRIPTION OF THE PREFERRED EMBODIMENTS

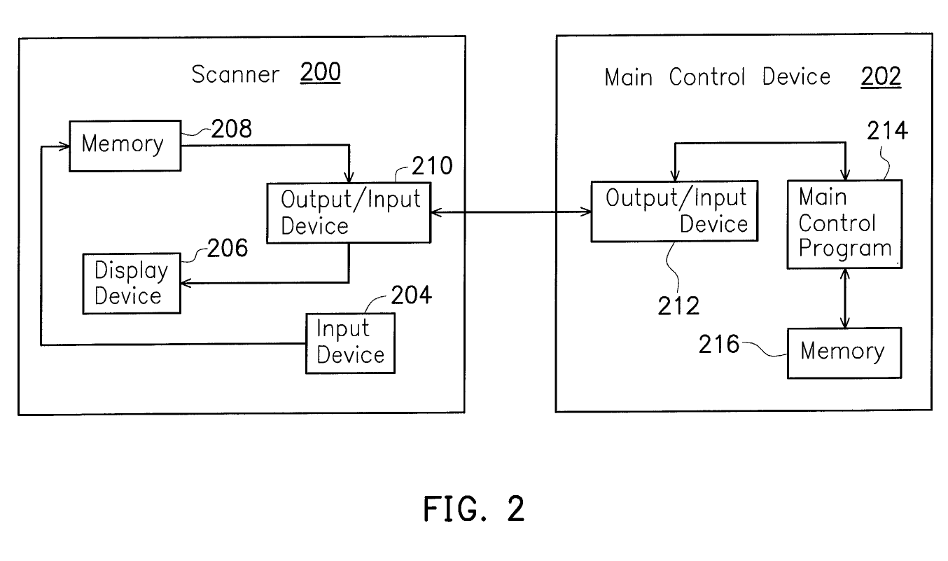

Referring to FIG. 2. It illustrates a scanner message display system according to one preferred embodiment of this invention. The main control device sends the message to a scanner, which displays the system message. The scanner message display system includes a main control program 214, a memory 216 and the display device 206.

More specifically, the main control program 214 is in the main control device 202. The main control program detects the language and the optional message selected by the user, and it also provides the full text message, the font and the icon. The message display is dependent on the language selected by the main control program 214, or the user selected language.

The main control device 202 is a computer that can be a personal computer, or a server computer, or a notebook computer. The main control program 214 could be an operational system or operating software. It should be noted that any operating software can operate the scanner 200 and that is the main control program 214.

The memory 216 is in the main control device 202 and couples the main control program 214, and displays messages, such as the operating state, any error messages, operation status, or setup hints when the scanner 200 is operating. The message can display full text, font or icons. The display device 206 is on the scanner surface and displays a message from the memory 216, and the language depends by the main control program 214. For example, if the main control program 214 uses Mandarin and the display device 206 will display a Mandarin message. The display device 206 could be a LCD module.

The scanner message display system further provides an output/input device 212, a memory 208, an output/input device 210.

More specifically, the output/input device 212 is in the main control device 202 and couples to the main control program 214. The output/input device 212 receives the information from the scanner 200, and sends the message that are stored from memory 216 and displays them on the scanner 200.

The memory 208 is located in the scanner 200 and couples to the display device 206 and stores the information where the user selects. The output/input device 210 is in the scanner 200 and couples between the memory 208 and the display device 206, and sends optional messages stored in memory 208 out, and receives the information from the main control program 214 and displays on the display device 206.

More specifically, the input device 204 is in the scanner 200 and couples to the memory 208. The input device 204 inputs the optional message from the user. If the system does not have the input device 204 the system can still function. The input device 204 is could be push buttons and is located on the scanner 200. In this invention, the input device 204 could also be a LCD touch-screen. Therefore the input device 204 can be unnecessary in the system, because the input device 204 can replaced by the display device 206.

In this system, a cable is connected between the scanner 200 and the control device 202 to send messages, or a wireless method can do the same job.

In this preferred embodiment of this invention, inputted optional information is entered into the display device 206 or on the input device 204. When the control program 214 detects the message in the scanner 200, it sends the message to the main control device 202 by using the output/input devices 210 and 212, and compares the message with the memory 216. The main control program 214 captures the message from the memory 216 and outputs the message to the scanner 200 by using the output/input devices 212 to 210, and then the display device 206 of the scanner 200 displays the message.

Referring to FIG. 2 again. The element can detect the optional message and display it on the scanner. This scanner message display element includes the main control program 214, which detects the message selected by the user. Also, the main control program 214 can provide the full-text message, the font and the icon.

The method also allows for the detection of the language for the main control program 214 and if that language is already used in the main control program 214, or the a user selected language.

The main control program 214 is an operational system, and it is also operating software.

Referring to the FIG. 2 again. It illustrates another preferred embodiment of this invention for a scanner message display device. This device can display the message from the main control program. The scanner message display device is the scanner 200, which can send the selected message to the main control device 202 and also can display the message from the main control device 202.

The display device 206 is on the scanner 200 surface. The display device 206 uses the language that is detected by the main control program 214 and displays the message, which it is stored in memory 216.

The scanner message display device includes a memory 208, which is designed for storing the message. This memory 208 does not have a large capacity space, because the memory 208 only stores the coding message. The coding message does not need to store the text, the icon or any operating state of the scanner. Therefore the memory 208 can save on memory space, but it must provide the space to allow the main control program 214 to store various content messages in the memory 208 at any moment.

The output/input device 210 couples between the memory 208 and the display device 206 and sends the storing message from the memory 208 and receives the selected message from the main control device 202. The output/input device 210 also sends the message to the display device 206 that allows displaying the message. The input device 204 couples the memory 208 and allows the user to select and input the selected items to store in the memory. The display device 206 can replace the function of the input device 204. For example, a LCD touch-screen that allows the user to select and input the message item.

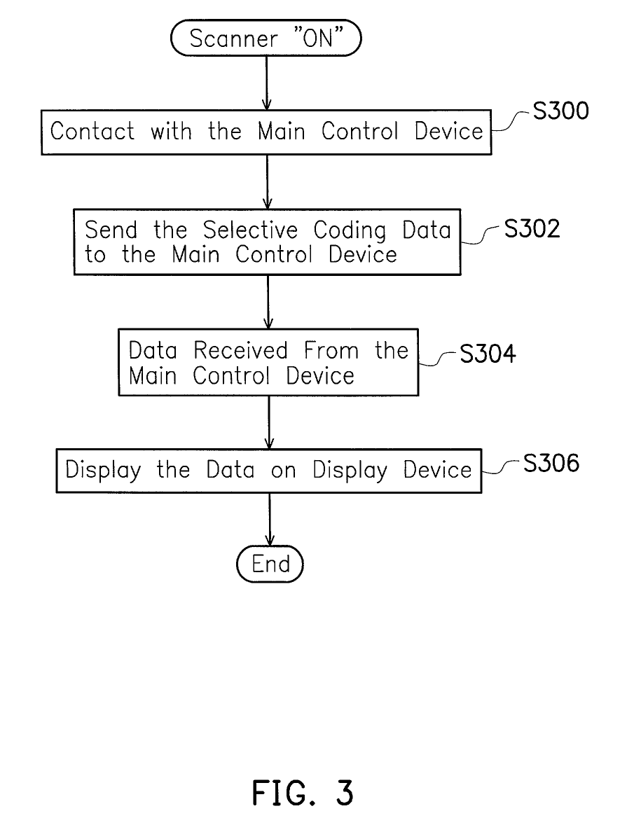

Referring to the FIG. 3. It illustrates another preferred embodiment of this invention for a scanner message display device and shows how the scanner displays the message from the main control program. The steps of the scanner message display method are as follows. Step S300, the scanner communicates with the main control program. Step S302, the selected message is coded and sent to the main control program. Step S304, the main control program receives the selected message. And finally in the step S306, the message displays on the display device of the scanner.

More particularly, the message provides an operating state of the scanner, the error message, operating indication and the setup hits, or the full text message detail, the font and the icon, etc.

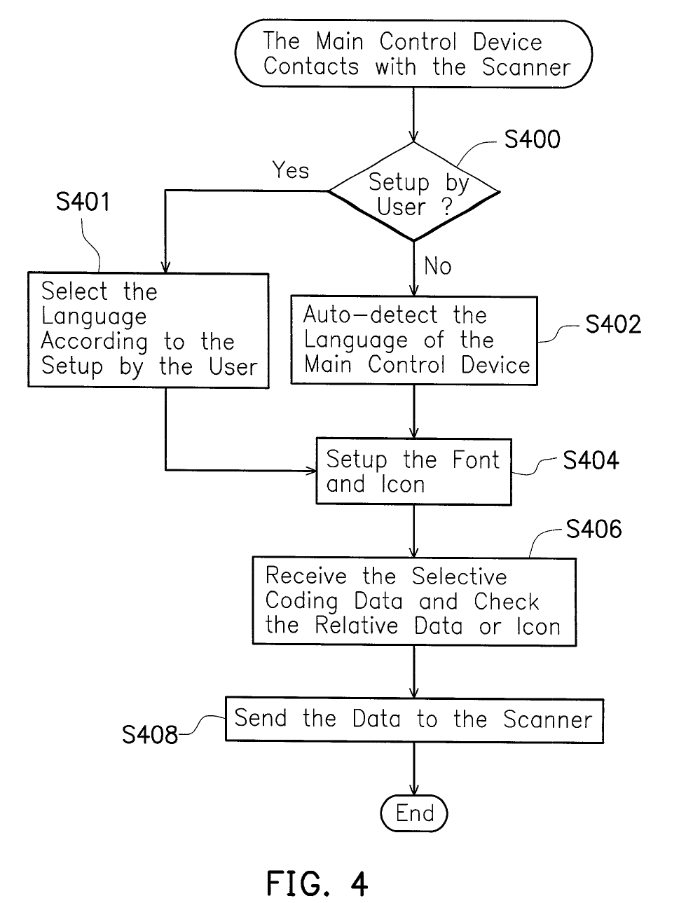

Referring to FIG. 4. It illustrates another preferred embodiment of a flow diagram of this invention for a scanner message display device, and shows the program for main control program detection of the selected message that is set up by the user.

The steps of the scanner message display method are as follows. In first step S400, the main control device detects the whether a language has been set by the user. If the user has set up the language, then in the next step S401, the scanner display the message according the language. If the user has not set up the language, then go to the step S402, where the main control program detects the language automatically. Next step S404, the scanner display the font or icon according the language in the last step. Step S406, the scanner receives and double-checks the selected message. And final step S408, the message is sent to the scanner.

More specifically, the message provides the operating state of the scanner, the error message, the operation status, and the setup hints.

Compare all the foregoing description, the advantage of this invention are:

1. It can display complicated, but user0-friendly messages.

2. It can automatically change and display the language, and the font.

3. It can display a variety of icon interfaces.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A scanner message display system with a main control device that sends a plurality of messages to a scanner, wherein the scanner displays the message in the system, comprising:
a main control program, contained in the main control device for detecting a language and a message item that is selected by a user;
a primary memory, in the main control device that couples to the main control program and stores messages when the scanner is operating; and
a display device, on a surface of the scanner, for display the message from the primary memory and detecting the language in the main control program according the language message that is stored in the primary memory, wherein the primary memory provides a full text message, a font and a icon of the message item.

2. The system of claim 1, wherein the scanner message display system, comprising:
a first output/input device, in the main control device for coupling to the main control program, for receiving the message from the scanner, and for sending the message to the main control program and displaying on the scanner.

3. The system of claim 1, wherein the scanner message display system, comprising:
a secondary memory, in the scanner for the display device, that stores the setup message item that are selected by the user;
a second output/input device, in the scanner for coupling between the secondary memory and the display device, for sending the message from the secondary memory, and for receiving the selected message from the main control program; and
an input device, placed in the scanner for coupling to the secondary memory, and for storing the selected message by user input.

4. The system of claim 3, wherein the secondary output/input device receives the message and sends it to the display device and display.

5. The system of claim 1, wherein the display device allows for the user to input selected messages on the display device.

6. The system of claim 1, wherein the primary memory stores the message and provides an operating status, an error message, and a setup hints for the scanner.

7. The system of claim 1, wherein the primary memory stores messages comprised of full text messages, the font and the icon.

8. The system of claim 1, wherein a cable is used for sending messages between the scanner and the main control device.

9. The system of claim 1, wherein a wireless method is used for sending message between the scanner and the main control device.

10. The system of claim 1, wherein the main control program is an operating system.

11. The system of claim 1, wherein the main control program is operating software.

12. The system of claim 1, wherein the main control device is a computer.

13. The system of claim 1, wherein the language is either detected from the main control program, or selected by the user in the main control program.

14. A component of a scanner message display system that detects a selected message and displays a plurality of message on the scanner, the component of a scanner message display system is a main control program that detects a language and a message item that is set up by the user, wherein the main control program provides a message item of a full text message, a font and an icon.

15. The component of claim 14, wherein the main control program is an operating system.

16. The component of claim 14, wherein the main control program is operating software.

17. The component of claim 14, wherein the main control device is a computer.

18. The component of claim 14, wherein the language is either detected from the main control program, or selected by the user in the main control program.

19. A device of the scanner message display system, for displaying a plurality of messages from a main control program, the scanner message display device is a scanner, for sending a selected message to the main control program and displaying the message provided from the main control program, wherein a display device is on a surface of scanner and displays the language message where the source comes from the main control program.

20. The device of claim 19, wherein the scanner message display device, comprises:
a secondary memory, storing a set up message item by a user;
a secondary output/input device, coupling between the secondary memory and the display device, for sending the storing message detail in the secondary memory, and for receiving the selected message from the main control program.

21. The device of claim 20, wherein the secondary output/input device receives the message and sends it to the display device, and the display device displays the message.

22. The device of claim 19, wherein the display device allows the user to input the selected message.

23. A method of the scanner message display, when a scanner displays a plurality of messages from a main control program, the method of the scanner message display, comprising the steps of:
contacting with the main control program;
converting a selected message into a coding signal and sending it to the main control program;
receiving the selected message from the main control program; and
displaying the message on a display device of the scanner.

24. The method of claim 23, wherein the message comprises an operating status, an error message, and setup hints for the scanner.

25. The method of claim 23, wherein the message comprises a full text message, a font and an icon of the message item.

26. A method of the scanner message display, when a main control program detects a selected message that is selected from the user on the scanner, comprising the steps of:
determining whether or not the user has selected a language on the scanner;
displaying a message in the language selected by the user if the user selects a language;
detecting the language automatically from the main control program if the user does not select the language;
displaying the font and the icon on the scanner according to either the language selected by the user, or the language detected by the main control program;
receiving a selected message from the scanner;
checking the message; and
sending the message to the scanner.

27. The method of claim 26, wherein the message provides the scanner an operating status, an error message, and a setup hints.
